(19) United States
(12) Patent Application Publication
(10) Pub. No.: US 2018/0303115 A1
(43) Pub. Date: Oct. 25, 2018

(54) FAT SPREAD CONTAINING MILKFAT AND VEGETABLE OILS

(71) Applicant: VALIO LTD., Helsinki (FI)

(72) Inventor: Annamari JUKKOLA, Helsinki (FI)

(21) Appl. No.: 15/768,092

(22) PCT Filed: Oct. 17, 2016
(86) PCT No.: PCT/FI2016/050725

§ 371 Date: Apr. 13, 2018

(30) Foreign Application Priority Data
Oct. 15, 2015 (FI) 20155729

(51) Int. Cl. A23D 7/005; A23D 7/05; A23C 19/076; A23C 9/13

(52) U.S. Cl. CPC A23D 7/0056; A23D 7/05; A23V 2250/1882; A23C 9/1315; A23V 2002/00; A23C 19/0765

(57) ABSTRACT

The present invention relates to a fat spread composition in oil-in-water emulsion comprising milk fat, vegetable oil(s), an acidified milk-based mass and water, wherein pH of the spread is in the range of 4.8-6.5 and the fat content of the spread is in the range of 30 to 60% (w/w) based on the weight of the composition. In a second aspect, the invention relates to a method for producing a fat spread, wherein said method comprises the steps of: a) providing a water phase, b) providing an oil phase, c) emulsifying the oil phase into the water phase to provide an oil-in-water emulsion, d) heat-treating the formed emulsion, e) optionally homogenizing the emulsion, f) cooling the emulsion, g) providing a spread, h) optionally packing the spread.

### FIELD OF THE INVENTION

The present invention relates to a milk-based fat spread composition. In addition, the present invention relates to a process for manufacturing a milk-based fat spread composition.

### BACKGROUND OF THE INVENTION

Butter and fat spread are foods in the form of an emulsion, mainly water-in-oil type emulsion, comprising principally an aqueous phase and edible fats and oils mainly composed of triglycerides of fatty acids of vegetable, animal, milk or marine origin. According to IDF standard, fat spreads shall be classified into three groups i.e., milk fat products, mixed fat products and margarine products, based on the origin of the fat. In milk fat products such as butter, the fat is 100% from milk fat. In mixed fat products, 10-80% of the total fat is milk fat and in margarine products only 3% (max.) of the total fat is milk fat. The maximum fat content shall be about 90%.

Milk fat mainly consists of hard fat. It is, however, undisputedly the most varied naturally occurring fat, containing more than 400 identified fatty acids, each of which has unique physiological effects. The physical properties of milk fat also affect the taste. The extensive melting range of milk fat (−40 to +40° C.) together with the melting rate produce a pleasant mouthfeel when having products containing milk fat, and they play an important role in providing products containing milk fat with savouriness. Milk fat has positive taste properties that may be influenced in an end product by adjusting the milk fat content. Milk fat, its fatty acid composition and keto acids, hydroxy acids and lactones occurring in small quantities influence the formation of the basic taste and aroma of fat. It is considered characteristic of the lactones of milk fat to be capable of attaching and enhancing taste, which is a factor affecting the stability of taste and aroma. (Alivaara, Voi: raaka-aine-valmistus-arvostelu, 1971).

It is well known that owing to the tight water-in-oil emulsion structure, for example, low-fat spreads often have poor melting and taste properties. Such a structure is necessary for the stability of the emulsion. By using milk protein and various stabilizing systems, quality characteristics affecting the taste of the product may be improved. (Gerstenberg, P., Dairy Industries International 7/2008: 24 to 27).

Significant factors affecting the organoleptic properties, such as taste, deterioration of taste in particular, of spreads include the fat content, the composition of fat, and the composition of an aqueous phase. Off-smells, off-tastes or off-flavors and defect descriptions typical of edible fats include aromaless (flat), mild, cheesy, bitter, off-flavor, acrid, metallic flavor, oily. Defects in terms of the appearance and texture of spreads are described as follows: loose, emulsion partly upside down, thick, unguentous, sticky, soft, short, brittle, oil separation, flaky, porous, loose water.

### BRIEF DESCRIPTION OF THE INVENTION

The present invention relates to a milk-based fat spread composition. Specifically, the present invention relates to a milk-based fat spread composition comprising milk fat, plant oil(s), acidified dairy mass and water. More specifically, the present invention relates to a milk-based fat spread composition comprising milk fat, plant oil(s), acidified dairy mass and water and containing about 30 to 60% fat as calculated from the total weight of the product. The fat spread composition of the present invention is an emulsion having a continuous water phase and a dispersed oil phase (oil-in-water emulsion). The fat spread composition contains high amounts of unsaturated fatty acids. The pH of the milk-based fat spread composition is in the range of 4.8-6.5.

In addition, the present invention relates to a process for manufacturing a milk-based fat spread composition. The process for manufacturing a milk-based fat spread composition of the present invention comprises the steps of:

a) providing a water phase,

b) providing an oil phase,

c) emulsifying the oil phase into the water phase,

d) heat-treating and cooling the formed emulsion,

e) providing a spread,

f) optionally packing the spread.

The objects of the invention are achieved by compositions and methods characterized by what is stated in the independent claims. The preferred embodiments of the invention are disclosed in the dependent claims.

### DETAILED DESCRIPTION OF THE INVENTION

In the market, there is a continuous need for spread compositions, which have a low or lowered fat content i.e., a fat content of about 30-60% (w/w), which contain high amounts of unsaturated fatty acids and which have a pleasant mouthfeel.

The invention is based on a finding, that a low fat spread containing high amounts of unsaturated fatty acids including omega-3 fatty acids, can be obtained by formulating an oil phase into a water phase containing acidified dairy mass, such as quark, into an oil-in-water emulsion. The fat spread has a fresh and flavoured taste. The flavor release of the fat spread is good. There is no need to supplement the composition with aroma agents. In addition, the fat spread composition of the present invention has a good melting curve in view of providing a pleasant melt in the mouth of a human. The fat spread composition of the present invention is suitable in addition to for spreading also for cooking and baking.

Accordingly, the present invention relates to a milk-based fat spread composition. Specifically, the present invention relates to a milk-based fat spread composition comprising milk fat (butter, butter oil), vegetable oil(s), an acidified dairy mass and water. More specifically, the present invention relates to a milk-based fat spread composition comprising milk fat, plant oil(s), acidified dairy mass and water and containing about 30 to 60% fat as calculated from the total weight of the product. The fat spread composition of the present invention contains high amounts of unsaturated fatty acids in oil-in-water emulsion. The pH of the milk-based fat spread composition is in the range of 4.8-6.5. The fat spread composition may comprise also salt. The fat spread composition may comprise also starch. The fat spread composition may comprise also a hydrocolloid. The fat spread composition may comprise also an emulsifier. The fat spread composition may comprise also an acid taste neutralizer.

The fat spread of the present invention contains about 30 to 60% fat as calculated from the total weight of the product. In one embodiment, the fat spread composition of the present invention contains about 40 to 60% fat as calculated from the total weight of the product. In one embodiment, the fat spread composition of the invention contains about 30 to 40% fat as calculated from the total weight of the product. In one embodiment, the fat spread composition of the invention contains about 30% fat as calculated from the total weight of the product. In one embodiment, the fat spread composition of the invention contains about 40% fat as calculated from the total weight of the product. In one embodiment, the fat spread composition of the invention contains about 60% fat as calculated from the total weight of the product.

The fat spread composition of the invention comprises milk fat and vegetable oil(s). In one embodiment, the fat spread composition of the present invention contains about 30 to 60% fat, of which the percentage of milk fat is about 25 to 50%. In one embodiment, the fat spread composition of the present invention contains about 30 to 60% fat, of which the percentage of milk fat is about 40 to 50%. In one embodiment, the fat spread of the present invention contains about 30 to 40% of fat as calculated from the total weight of the product. In one embodiment, the fat spread composition of the present invention contains about 30 to 40% fat, of which the percentage of milk fat is about 25 to 50%. In one embodiment, the fat spread composition of the present invention contains about 30 to 40% fat, of which the percentage of milk fat is about 40 to 50%. In one embodiment, the proportion of milk fat is about 33% based on the total fat content of the fat spread. In one embodiment, the proportion of milk fat is about 50% based on the total fat content of the fat spread.

In one embodiment, the fat spread composition of the present invention contains about 50 to 75% of vegetable oil(s) based on the total fat content of the spread. In one embodiment, the fat spread composition of the present invention contains about 30 to 40% fat, of which the percentage of vegetable oil(s) is about 50 to 75%. In one embodiment, the fat spread composition of the present invention contains about 30 to 40% fat, of which the percentage of vegetable oil(s) is about 50 to 70%. In one embodiment, the proportion of vegetable oil(s) is about 50% based on the total fat content of the fat spread. In one embodiment, the proportion of vegetable oil(s) is about 67% based on the total fat content of the fat spread.

In the present invention, the vegetable oil may be rapeseed oil, sunflower oil, olive oil, maize oil, or any other non-hydrogenated vegetable oil or any combination thereof. In one embodiment, the vegetable oil is rapeseed oil or sunflower oil or a combination thereof.

In one embodiment the amount of saturated fatty acids in the fat spread composition is in the range of about 25-40% based on the total weight of fatty acids in the composition. In one embodiment the amount of saturated fatty acids in the fat spread composition is in the range of 27-30% based on the total weight of fatty acids in the composition. In one embodiment the amount of saturated fatty acids in the fat spread composition is in the range of 38-40% based on the total weight of fatty acids in the composition.

In one embodiment the amount of monounsaturated fatty acids in the fat spread composition is in the range of about 23-53% based on the total weight of fatty acids in the composition In one embodiment the amount of monounsaturated fatty acids in the fat spread composition is in the range of about 25-50% based on the total weight of fatty acids in the composition. In one embodiment the amount of monounsaturated fatty acids in the fat spread composition is in the range of about 43-50% based on the total weight of fatty acids in the composition.

In one embodiment the amount of polyunsaturated fatty acids in the fat spread composition is in the range of about 15-45% based on the total weight of fatty acids in the composition. In one embodiment the amount of polyunsaturated fatty acids is in the range of about 20-45% based on the total weight of fatty acids in the composition. In one embodiment the amount of polyunsaturated fatty acids in the fat spread composition is in the range of 20-35% based on the total weight of fatty acids in the composition.

In one embodiment, the fat spread of the present invention contains saturated fatty acids in the range of about 25-40%, monounsaturated fatty acids in the range of about 25-50% and polyunsaturated fatty acids in the range of about 15-45% based on the total weight of fatty acids in the composition. In one embodiment, the fat spread of the present invention contains saturated fatty acids in the range of about 27 to 30%, monounsaturated fatty acids in the range of about 25-50% and polyunsaturated fatty acids in the range of about 20-45% based on the total weight of fatty acids in the composition. In one embodiment, the fat spread of the present invention contains saturated fatty acids in the range of about 38-40%, monounsaturated fatty acids in the range of about 25-45% and polyunsaturated fatty acids in the range of about 15-35% based on the total weight of fatty acids in the composition.

In one embodiment the amount of omega-3 fatty acids in the fat spread composition is in the range of about 0.2 to 7% based on the weight of the polyunsaturated fatty acids in the composition. In one embodiment the amount of omega-3 fatty acids in the fat spread composition is in the range of about 0.2 to 6.5% based on the weight of the polyunsaturated fatty acids in the composition. In one embodiment the amount of omega-3 fatty acids in the fat spread composition is in the range of about 0.3 to 5% based on the weight of the polyunsaturated fatty acids in the composition.

In one embodiment the amount of omega-6 fatty acids in the fat spread composition is in the range of 10 to 45% based on the total weight of the polyunsaturated fatty acids in the composition. In one embodiment the amount of omega-6 fatty acids in the fat spread composition is in the range of 15 to 45% based on the total weight of the polyunsaturated fatty acids in the composition. In one embodiment the amount of omega-6 fatty acids in the fat spread composition is in the range of 10 to 35% based on the total weight of the polyunsaturated fatty acids in the composition.

In one embodiment, the content of C18:1-fatty acids, including the isomers, is in the range of about 22 to 48% (w/w) based on the total weight of the fatty acids in the composition. In one embodiment, the content of C18:1-fatty acids, including its isomers, is in the range of about 40 to 48% (w/w) based on the total weight of the fatty acids in the composition. In one embodiment, the content of C18:1-fatty acids, including its isomers, is in the range of about 22-24% (w/w) based on the total weight of the fatty acids in the composition.

In one embodiment, the content of C18:2, n-6-fatty acids is in the range of about 10 to 45% (w/w) based on the total weight of the fatty acids in the composition. In one embodiment, the content of C18:2, n-6-fatty acids is in the range of about 30 to 45% (w/w) based on the total weight of the fatty acids in the composition. In one embodiment, the content of C18:2, n-6-fatty acids is in the range of about 10 to 15% (w/w) based on the total weight of the fatty acids in the composition.

In one embodiment, the content of C4:0 fatty acid is in the range of about 1 to 2% (w/w) based on the total weight of the fatty acids in the composition. In one embodiment, the content of C4:0 fatty acid is in the range of about 1.1 to 1.8% (w/w) based on the total weight of the fatty acids in the composition. In one embodiment, the content of C4:0 fatty acid is in the range of about 1.1 to 1.2% (w/w) based on the total weight of the fatty acids in the composition.

In one embodiment, the fatty acid profile of the fat spread composition comprises the following fatty acids:

| | |
|---|---|
| C4:0 | 1 to 2% |
| C16:0 | 12 to 18.5% |
| C18:0 | 4.5 to 7.5% |
| C18:3, n-3-cis | 0.2 to 6.5% |

based on the total weight of the fatty acids in the composition.

In one embodiment, the fatty acid profile of the fat spread composition comprises the following fatty acids (w/w):

| | |
|---|---|
| C4:0 | 1 to 2% |
| C4:0 + C6:0 + C8:0 + C10:0 | 3 to 5.2% |
| C14:0 | 3.6 to 5.9% |
| C16:0 | 12 to 18.5% |
| C18:0 | 4.5 to 7.5% |
| C18:1 + isomers | 22 to 48% |
| C18:2, n-6-cis | 10 to 45% |
| C18:3, n-3-cis | 0.2 to 6.5%, |

based on the total weight of the fatty acids in the composition.

In one embodiment, the fat spread composition contains about 8 to 25% (w/w) saturated fatty acids based on the total weight of the fat spread composition. In one embodiment, the fat spread composition contains about 8 to 30% (w/w) monounsaturated fatty acids based on the total weight of the fat spread composition. In one embodiment, the fat spread composition contains about 5 to 26% (w/w) polyunsaturated fatty acids based on the total weight of the fat spread composition. In one embodiment, the fat spread composition contains about 8 to 25% (w/w) saturated fatty acids, about 13 to 56% (w/w) unsaturated fatty acids of which about 8 to 30% (w/w) are mono-unsaturated fatty acids and about 5 to 26% (w/w) are polyunsaturated fatty acids based on the total weight of the fat spread composition. In one embodiment, the fat spread composition contains about 8 to 17% (w/w) saturated fatty acids, about 13 to 38% (w/w) unsaturated fatty acids of which about 8 to 20% (w/w) are mono-unsaturated fatty acids and about 5 to 18% (w/w) are polyunsaturated fatty acids based on the total weight of the fat spread composition In one embodiment, the fat spread composition contains about 11 to 25% (w/w) saturated fatty acids, about 17 to 56% (w/w) unsaturated fatty acids of which about 10 to 30% (w/w) are mono-unsaturated fatty acids and about 7 to 26% (w/w) are polyunsaturated fatty acids based on the total weight of the fat spread composition. In one embodiment, the fat spread composition contains about 8 to 13% (w/w) saturated fatty acids, about 8 to 15% (w/w) mono-unsaturated fatty acids and about 5 to 15% (w/w) polyunsaturated fatty acids based on the total weight of the fat spread composition. In one embodiment, the fat spread composition contains about 11 to 17% (w/w) saturated fatty acids, about 10 to 20% (w/w) mono-unsaturated fatty acids and about 7 to 18% (w/w) polyunsaturated fatty acids based on the total weight of the fat spread composition. In one embodiment, the fat spread composition contains about 16 to 25% (w/w) saturated fatty acids, about 15 to 30% (w/w) mono-unsaturated fatty acids and about 10 to 26% (w/w) polyunsaturated fatty acids based on the total weight of the fat spread composition.

In one embodiment, the fat spread composition contains about 12% (w/w) saturated fatty acids, about 27% (w/w) unsaturated fatty acids of which about 18% (w/w) are mono-unsaturated fatty acids and about 8.7% (w/w) are polyunsaturated fatty acids based on the total weight of the fat spread composition. In one embodiment, the fat spread composition contains about 8% (w/w) saturated fatty acids, about 21% (w/w) unsaturated fatty acids of which about 15% (w/w) are mono-unsaturated fatty acids and about 6% (w/w) are polyunsaturated fatty acids based on the total weight of the fat spread composition. In one embodiment, the fat spread composition contains about 16% (w/w) saturated fatty acids, about 43% (w/w) unsaturated fatty acids of which about 30% (w/w) are mono-unsaturated fatty acids and about 13% (w/w) are polyunsaturated fatty acids based on the total weight of the fat spread composition.

The fat spread composition of the present invention contains acidified dairy mass, such as quark, acidified buttermilk and/or yogurt, for example. In the present invention, the acidified dairy mass refers to quark, tvorog, skyr, yogurt, greek yogurt, acidified buttermilk and any mixture thereof. The acidified dairy mass, such as quark, acidified buttermilk and/or yogurt, suitable for the fat spread composition of the present invention can be a low fat/fat free product or a full fat product. The acidified dairy mass suitable for the fat spread composition of the present invention can be low lactose/lactose-free product or a lactose containing product.

In one embodiment, acidified milk-based mass is quark, acidified buttermilk or a quark type mass. Quark is unripened fresh cheese which is made from pasteurized skim milk and/or buttermilk by adding an acidifier to the milk. Typically, a small amount of rennet is also added. Quark has a smooth texture and mild, acid flavour. Quark, acidified buttermilk or a quark type acidified mass is typically acidified with a mesophilic starter, such as Lactococcus lactis ssp. cremoris, Lactococcus lactis ssp. lactis, Leuconostoc mesenteroides ssp. cremoris and/or Lactococcus lactis ssp. diacetylactis, or a chemical acidifier.

The quark may be produced with any method suitable for manufacturing quark. Such methods are known to the person skilled in the art. The quark of the present invention may also be produced with a method differing from a typical method for producing quark wherein no rennet is used and no thermization and separation steps are performed in the method.

In one embodiment, the acidified milk based mass is yogurt. Yogurt is a fermented milk product produced by lactic acid bacterial fermentation of milk. The bacteria used to make yogurt are known as “yogurt cultures”. Fermentation of lactose by these bacteria produces lactic acid, which acts on milk protein to give yogurt its texture and its characteristic tang. Yogurt is typically acidified with a thermophilic acidifier or starter, such as Lactococcus lactis ssp. cremoris, Lactococcus lactis ssp. lactis, Leuconostoc mesenteroides ssp. cremoris and/or Lactococcus lactis ssp. diacetylactis, or a chemical acidifier.

Yogurt may be produced with any method suitable for manufacturing yogurt. Such methods are well-known to the person skilled in the art.

In one embodiment, the acidified milk-based mass is a mixture of quark and yogurt. In one embodiment, the amount of quark in the mixture of quark and yogurt is in the range of about 1% to about 99% (w/w). In one embodiment, the amount of quark in the mixture of quark and yogurt is in the range of about 65% to about 35%.

The protein content of the acidified milk-based mass is in the range of 4-15% (w/w), based on the total weight of the acidified milk-based mass. In one embodiment, the protein content of the acidified milk-based mass is in the range of 8-15% (w/w), based on the total weight of the acidified milk-based mass. In one embodiment, the protein content of the acidified milk-based mass is in the range of 10-12% (w/w), based on the total weight of the acidified milk-based mass. In one embodiment, the protein content of the acidified milk-based mass is in the range of about 4-8% (w/w), based on the total weight of the acidified milk-based mass.

The fat spread composition of the present invention contains the acidified milk-based mass in an amount of about 20 to 50% (w/w) based on the total weight of the fat spread composition. In one embodiment, the fat spread composition comprises about 25-30% (w/w) of an acidified milk-based mass based on the total weight of the fat spread composition In one embodiment, the fat spread composition comprises about 34-36% (w/w) of an acidified milk-based mass based on the total weight of the fat spread composition. In one embodiment, the fat spread composition comprises about 40 to 50% (w/w) of an acidified milk-based mass based on the total weight of the fat spread composition.

The protein content in the fat spread composition of the present invention is in the range of about 1 to 6.5% (w/w) based on the total weight of the fat spread composition. In one embodiment, the protein content in the fat spread composition is in the range of 3 to 5% (w/w) based on the total weight of the fat spread composition.

The fat spread composition of the present invention contains water in an amount of about 10 to 25% (w/w) based on the total weight of the fat spread composition. In one embodiment, the fat spread composition comprises water about 12-15% (w/w) based on the total weight of the fat spread composition. In one embodiment, the fat spread composition comprises water about 16-18% (w/w) based on the total weight of the fat spread composition. In one embodiment, the fat spread composition comprises water about 20 to 23% (w/w) based on the total weight of the fat spread composition.

In one embodiment, the fat spread composition of the present invention contains salt in an amount of about 0.5 to about 1%. Accordingly, the sodium content of the spread composition is at most 400 mg/100 g. The sodium content of a food product is a significant factor from the health point of view.

The fat spread composition of the present invention may contain at least one hydrocolloid. In the present invention, the hydrocolloid can be selected from pectin, gelatin, starch, starch hydrolysates, xanthan gum, gum arabic, guar gum, gellan gum, acacia, agar agar, alginates konjac, mannan, pullulan, carob, beta glucan, carrageen, polydextrose, cellulose and/or cellulose derivatives. The amount of the hydrocolloid(s) used in the process depends on the characteristics of the hydrocolloid(s) and/or amounts of the other components of the milk based fat composition, for example. In one embodiment, the amount of the hydrocolloid is in the range of 0-1% (w/w) based on the weight of the fat spread composition. In one embodiment, the amount of the hydrocolloid is in the range of 0.6-0.8% (w/w) based on the weight of the fat spread composition. In one embodiment the hydrocolloid is pectin. In one embodiment, the hydrocolloid comprises pectin and starch. In one embodiment, the hydrocolloids are pectin and starch.

The fat spread composition of the present invention may contain an emulsifier. The emulsifier can be selected from emulsifiers known to be suitable for fat spread compositions, such as glycerol based emulsifiers, mono- and diglycerides of fatty acids, various phosphates and lecithin, for example. The amount of the emulsifier(s) used in the process depends on the characteristics of the emulsifier(s) and/or amounts of the other components of the milk based fat composition, for example. In one embodiment, the amount of the emulsifier is in the range of 0-2% (w/w) based on the weight of the fat spread composition. In one embodiment, the amount of the emulsifier is in the range of 1-1.5% (w/w) based on the weight of the fat spread composition.

The fat spread composition of the present invention may contain starch. In one embodiment, the amount of starch is in the range of 0-2.5% (w/w) based on the weight of the fat spread composition. In one embodiment, the amount of starch is about 2% (w/w) based on the weight of the fat spread composition.

In one embodiment, the milk based fat spread composition of the present invention contains fat about 30 to about 40% (w/w). In this embodiment, the milk based fat spread composition comprises about 30-50% (w/w) an acidified milk based product, about 10-25% (w/w) water, about 15-25% (w/w) milk fat, about 15-27% (w/w) vegetable oil. In one embodiment, the milk based fat spread composition comprises also salt in an amount of 0.5-1% (w/w). In one embodiment, the milk based fat spread composition comprises also starch in an amount of 0-2.5% (w/w), a hydrocolloid in an amount of 0-1% (w/w), an emulsifier in an amount of 0-2% (w/w) and/or an acid taste neutralizer in an amount of 0-1.5% (w/w).

In one embodiment, the milk based fat spread composition of the present invention contains fat 40% (w/w). In this embodiment, the milk based fat spread composition comprises about 34-36% (w/w) an acidified milk based product, about 16-18% (w/w) water, about 17-23% (w/w) milk fat, about 22-25% (w/w) vegetable oil. In one embodiment, the milk based fat spread composition comprises also salt in an amount of 0.5-1.5% (w/w). In one embodiment, the milk based fat spread composition comprises also starch in an amount of 0-2.5% (w/w), a hydrocolloid in an amount of 0-1% (w/w), emulsifier in an amount of 0-2% (w/w) and/or an acid taste neutralizer in an amount of 0-1.5% (w/w). In one embodiment, the milk based fat composition comprises about 35.5% (w/w) an acidified milk based product. In one embodiment, the milk based fat spread composition comprises about 16.5% (w/w) water. In one embodiment, the milk based fat spread composition comprises about 17% (w/w) milk fat. In one embodiment, the milk based fat spread composition comprises about 25% (w/w) vegetable oil. In one embodiment, the milk based fat spread composition comprises about 35.5% (w/w) an acidified milk based product, about 16.5% (w/w) water, about 17% (w/w) milk fat, about 25% (w/w) vegetable oil. In one embodiment, the milk based fat spread composition comprises also salt in an amount of 0.5-1.5% (w/w). In one embodiment, the milk based fat composition comprises also salt in an amount of 0.8% (w/w). In one embodiment, the milk based fat spread composition comprises also starch in an amount of 0-2.5% (w/w), a hydrocolloid in an amount of 0-1% (w/w), emulsifier in an amount of 0-2% (w/w) and/or an acid taste neutralizer in an amount of 0-1.5% (w/w). In one embodiment, the milk based fat spread composition comprises starch in an amount of 2% (w/w). In one embodiment, the milk based fat spread composition comprises a hydrocolloid in an amount of 0.8% (w/w). In one embodiment, the milk based fat spread composition comprises an emulsifier in an amount of 1.5% (w/w). In one embodiment, the milk based fat spread composition comprises an acid taste neutralizer in an amount of 0.9% (w/w).

In one embodiment, the milk based fat spread composition of the present invention contains fat 30% (w/w). In this embodiment, the milk based fat spread composition comprises about 40-50% (w/w) an acidified milk based product, about 10-23% (w/w) water, about 15-17% (w/w) milk fat, about 16-18% (w/w) vegetable oil. In one embodiment, the milk based fat spread composition comprises also salt in an amount of 0.5-0.8% (w/w). In one embodiment, the milk based fat spread composition comprises also starch in an amount of 0-2.5% (w/w), a hydrocolloid in an amount of 0-1% (w/w), emulsifier in an amount of 0-2% (w/w) and/or an acid taste neutralizer in an amount of 0-1.5% (w/w). In one embodiment, the milk based fat spread composition comprises about 41% (w/w) an acidified milk based product. In one embodiment, the milk based fat spread composition comprises about 21% (w/w) of water. In one embodiment, the milk based fat spread composition comprises about 16% (w/w) milk fat. In one embodiment, the milk based fat spread composition comprises about 17% (w/w) of vegetable oil. In one embodiment, the milk based fat spread composition comprises about 41% (w/w) an acidified milk based product, about 21% (w/w) water, about 16% (w/w) milk fat, about 17% (w/w) vegetable oil. In one embodiment, the milk based fat spread composition comprises also salt in an amount of 0.5-1.5% (w/w). In one embodiment, the milk based fat spread composition comprises also salt in an amount of 0.8% (w/w). In one embodiment, the milk based fat spread composition comprises also starch in an amount of 0-2.5% (w/w), a hydrocolloid in an amount of 0-1% (w/w), emulsifier in an amount of 0-2% (w/w) and/or an acid taste neutralizer in an amount of 0-1.5% (w/w). In one embodiment, the milk based fat spread composition comprises starch in an amount of 2% (w/w). In one embodiment, the milk based fat spread composition comprises a hydrocolloid in an amount of 0.6% (w/w). In one embodiment, the milk based fat spread composition comprises an emulsifier in an amount of 1% (w/w). In one embodiment, the milk based fat spread composition comprises an acid taste neutralizer in an amount of 0.6% (w/w).

The fat spread composition of the present invention is typically free of aroma agents normally used in fat spread compositions. In one embodiment, the fat spread composition does not contain any aroma agents.

The fat spread composition of the present invention is typically free of preservatives. In one embodiment, the fat spread composition does not contain any preservatives.

The pH of the fat spread composition of the present invention is in the range of 4.8-6.5. In one embodiment, the pH of the fat spread composition is in the range of 4.8-5.5. In one embodiment, the pH is in the range of 5.0-5.4. In one embodiment, the pH is in the range of 5.0-5.2. In one embodiment, the pH is in the range of 5.2-5.4. In one embodiment, the pH is in the range of 5.5-6.5. The pH of the fat spread composition of the present invention is typically adjusted with an acidity regulator know in the art, such as citric acid, sodium phosphate and sodium carbonate, for example. The pH of the composition affects the preservability and the stability of the emulsion in the spread. In addition, the pH is important for the organoleptic properties of the spread. The pH is important also from the manufacturing point of view of the spread.

The solid fat content (SFC) of a fat spread composition of the present invention containing 40% fat was found to be lower than known water-in-oil fat spread compositions containing also 40% fat over a temperature range of 5 to 25° C. The dropping point of a fat spread composition of the present invention containing 40% fat was found to be higher than known water-in-oil fat spread compositions containing also 40% fat. In one embodiment, the solid fat content (SFC) of the fat spread composition of the present invention at 5° C. is in the range of 17 to 25%. In one embodiment, the solid fat content (SFC) of the fat spread composition of the present invention at 10° C. is in the range of 15 to 20%.

In addition, the present invention relates to a process for manufacturing a milk-based fat spread composition. In one embodiment, the present invention relates to a process for manufacturing a milk-based fat spread composition containing about 30 to 60% fat as calculated from the total weight of the product. In one embodiment, the present invention relates to a process for manufacturing a milk-based fat spread composition having a pH in the range of 4.8 to 6.5. In one embodiment, the present invention relates to a process for manufacturing a milk-based fat spread composition having a pH in the range of 4.8 to 5.5. In one embodiment, the present invention relates to a process for manufacturing a milk-based fat spread composition comprising milk fat (butter, butter oil), vegetable oil(s), an acidified dairy mass and water. In one embodiment, the present invention relates to a process for manufacturing a milk-based fat spread composition comprising milk fat, plant oil(s), acidified dairy mass and water and containing about 30 to 60% fat as calculated from the total weight of the product. In one embodiment, the present invention relates to a process for manufacturing a milk-based fat spread composition comprising milk fat, plant oil(s), acidified dairy mass and water and having a pH in the range of 4.8 to 6.5. In one embodiment, the present invention relates to a process for manufacturing a milk-based fat spread composition containing about 30 to 60% fat as calculated from the total weight of the product and having a pH in the range of 4.8 to 6.5.

The process for manufacturing a milk-based fat spread composition of the present invention comprises the steps of:

a) providing a water phase,

b) providing an oil phase,

c) emulsifying the oil phase into the water phase to provide an oil-in-water emulsion,

d) heat-treating the formed emulsion,

e) optionally homogenizing the emulsion,

f) cooling the emulsion,

g) providing a spread,

h) optionally packing the spread.

In one embodiment, step a) of the method of the present invention includes providing the components for water phase and preparing the water phase by mixing the components. The water phase comprises an acidified milk based mass, water and optionally also a hydrocolloid, starch and salts. In one embodiment, step a) comprises providing and mixing an acidified milk based mass, water and optionally also a hydrocolloid, starch and salts.

In one embodiment, the water phase comprises acidified milk based mass about 60-75% (w/w) based on the weight of the water phase. In one embodiment, the water phase comprises water about 25-40% (w/w) based on the weight of the water phase. In one embodiment, the water phase comprises acidified milk based mass about 65-70% (w/w) based on the weight of the water phase. In one embodiment, the water phase comprises water about 30-35% (w/w) based on the weight of the water phase.

The acidified milk-based mass may be selected from quark, tvorog, skyr, yogurt, greek yogurt, acidified buttermilk and any mixture thereof. In one embodiment, step b) of the method of the present invention includes providing the components for oil phase and preparing the oil phase by mixing the components. The oil phase comprises milk fat, vegetable oil and optionally an emulsifier. In one embodiment, step b) comprises providing and mixing milk fat, vegetable oil and optionally an emulsifier.

In one embodiment, the oil phase comprises milk fat about 25 to 50% (w/w) based on the weight of the oil phase, In one embodiment, the oil phase comprises vegetable oil about 50% to 75% (w/w) based on the weight of the oil phase, In one embodiment, the oil phase comprises milk fat about 40 to 50% (w/w) based on the weight of the oil phase. In one embodiment, the oil phase comprises vegetable oil about 50% to 60% (w/w) based on the weight of the oil phase,

The vegetable oil may be selected from rapeseed oil, sunflower oil, olive oil, maize oil, or any other non-hydrogenated vegetable oil or any combination thereof. In one embodiment, the vegetable oil is rapeseed oil or sunflower oil or a combination thereof.

Step c) of the method of the present invention includes emulsifying the oil phase into the water phase to provide an oil-in-water emulsion. The formation of the oil-in-water emulsion is performed by methods and conditions known to a person skilled in the art.

Step d) of the method of the present invention includes heat-treating the oil-in-water emulsion. The oil-in-water emulsion is heat-treated using a method and conditions known to a person skilled in the art. For example, conventional heat treatment methods such as pasteurization (heating at least at about 72° C. for at least 15 seconds), ESL treatment (heating for example at about 130° C. for 1 to 2 seconds), UHT treatment (heating for example at about 138° C. for 2 to 4 seconds) or high temperature pasteurization (heating at 95° C. for 5 minutes), are employed. In an embodiment, the pasteurization is carried out at about 82° C. In an embodiment, the pasteurization is carried out at about 82° C. for about 20 seconds.

After heat-treatment, the heat-treated emulsion is optionally homogenized. The homogenization is performed at low pressure, typically using a pressure in the range of 10 to 50 bar. In one embodiment, the homogenization is performed at 35 bar.

Step f) of the method of the present invention includes cooling the emulsion. The emulsion is cooled to a temperature of about 10 to 15° C. to provide a fat spread composition.

Accordingly, in one embodiment the present invention relates to a process for manufacturing a milk-based fat spread composition comprising the steps of:
a) providing a water phase comprising an acidified milk based mass and water
b) providing an oil phase comprising milk fat and vegetable oil,
c) emulsifying the oil phase into the water phase to provide an oil-in-water emulsion,
d) heat-treating the formed emulsion,
e) optionally homogenizing the emulsion,
f) cooling the emulsion,
g) providing a spread,
h) optionally packing the spread.

In one embodiment, step a) comprises addition of at least one hydrocolloid, and/or starch and/or a salt. In one embodiment, step a) comprises addition of an acidity regulator i.e., adjusting the pH. In one embodiment, the process for manufacturing the milk-based fat spread composition of the present invention comprises adjusting the pH of the spread to a range of 4.8 to 6.5. In one embodiment, the pH of the fat spread composition is adjusted to the range of 4.8-5.5. In one embodiment, the pH is adjusted to the range of 5.0-5.4. In one embodiment, the pH is adjusted to the range of 5.0-5.2. In one embodiment, the pH is adjusted to the range of 5.2-5.4. In one embodiment, the pH is adjusted to the range of 5.5-6.5.

In one embodiment, the process for manufacturing a milk-based fat spread composition of the present invention comprises the steps of:
a) providing a water phase comprising an acidified milk-based mass, water and an acidity regulator for adjusting the pH to a range of 4.8 to 6.5,
a) providing an oil phase,
b) emulsifying the oil phase into the water phase to provide an oil-in-water emulsion,
c) heat-treating the formed emulsion,
d) optionally homogenizing the emulsion,
e) cooling the emulsion,
f) providing a spread having a pH in the range of 4.8 to 6.5,
g) optionally packing the product.

Typically the pH is adjusted by using an acidity regulator generally used in dairy industry, such as citric acid, sodium phosphate and sodium carbonate, for example.

In one embodiment, step b) comprises addition of an emulsifier.

Thus, in one embodiment the present invention relates process for manufacturing a milk-based fat spread composition comprising the steps of:
a) providing a water phase comprising an acidified milk-based mass, water and optionally at least one hydrocolloid, salts and/or an acidity regulator,
b) providing an oil phase comprising milk fat, vegetable oil and optionally an emulsifier,
c) emulsifying the oil phase into the water phase to provide an oil-in-water emulsion,
d) heat-treating the formed emulsion,
e) optionally homogenizing the emulsion,
f) cooling the emulsion,
g) providing a spread,
h) optionally packing the spread.

In one embodiment, the present invention relates to a process for manufacturing a milk-based fat spread composition comprising the steps of:
a) providing a water phase comprising an acidified milk based mass about 60-75% (w/w) and water about 25-40% (w/w) based on the weight of the water phase,
b) providing an oil phase comprising milk fat about 25 to 50% (w/w) and vegetable oil about 50-75% (w/w) based on the weight of the oil phase,
c) emulsifying the oil phase into the water phase to provide an oil-in-water emulsion,
d) heat-treating the formed emulsion,
e) optionally homogenizing the emulsion,
f) cooling the emulsion,
g) providing a spread,
h) optionally packing the spread.

In one embodiment, the present invention relates to a process for manufacturing a milk-based fat spread composition comprising the steps of:
a) providing a water phase comprising an acidified milk based mass about 65-70% (w/w) and water about 30-35% (w/w) based on the weight of the water phase,
b) providing an oil phase comprising milk fat about 25 to 50% (w/w) and vegetable oil about 50-75% (w/w) based on the weight of the oil phase,
c) emulsifying the oil phase into the water phase to provide an oil-in-water emulsion,
d) heat-treating the formed emulsion,
e) optionally homogenizing the emulsion,
f) cooling the emulsion,
g) providing a spread,
h) optionally packing the spread.

In one embodiment, the present invention relates to a process for manufacturing a milk-based fat spread composition comprising the steps of:
a) providing a water phase comprising an acidified milk based mass about 60-75% (w/w) and water about 25-40% (w/w) based on the weight of the water phase,
b) providing an oil phase comprising milk fat about 40 to 50% (w/w) and vegetable oil about 50-60% (w/w) based on the weight of the oil phase,
c) emulsifying the oil phase into the water phase to provide an oil-in-water emulsion,
d) heat-treating the formed emulsion,
e) optionally homogenizing the emulsion,
f) cooling the emulsion,
g) providing a spread,
h) optionally packing the spread.

In one embodiment, the present invention relates to a process for manufacturing a milk-based fat spread composition comprising the steps of:
a) providing a water phase comprising an acidified milk based mass about 65-70% (w/w) and water about 30-35% (w/w) based on the weight of the water phase,
b) providing an oil phase comprising milk fat about 40 to 50% (w/w) and vegetable oil about 50-60% (w/w) based on the weight of the oil phase,
c) emulsifying the oil phase into the water phase to provide an oil-in-water emulsion,
d) heat-treating the formed emulsion,
e) optionally homogenizing the emulsion,
f) cooling the emulsion,
g) providing a spread,
h) optionally packing the spread.

In one embodiment, step a) comprises addition of at least one hydrocolloid in an amount of 0-1% (w/w). In one embodiment, step a) comprises addition of at least one hydrocolloid in an amount of 0.6% (w/w). In one embodiment, step a) comprises addition of starch in an amount of 0-2.5% (w/w). In one embodiment, step a) comprises addition of starch in an amount of 2% (w/w). In one embodiment step a) comprises addition of a salt in an amount of 0.5-1.5% (w/w). In one embodiment step a) comprises addition of a salt in an amount of 0.8% (w/w). In one embodiment, step a) comprises adjusting the pH. In one embodiment, the pH is adjusted to a range of 4.8 to 6.5. In one embodiment, the pH is adjusted to a range of 4.8 to 5.5. In one embodiment, the pH is adjusted to the range of 5.0 to 5.4. In one embodiment, the pH is adjusted to the range of 5.0-5.2. In one embodiment, the pH is in the range of 5.5 6.5.

In one embodiment, step a) comprises addition of an acid taste neutralizer in an amount of 0-1.5% (w/w). In one embodiment, step a) comprises addition of an acid taste neutralizer in an amount of 0.6% (w/w).

In one embodiment, step b) comprises addition of an emulsifier in an amount of 0-2% (w/w). In one embodiment, step b) comprises addition of an emulsifier in an amount of 1% (w/w).

The manufacture of fat spreads may be divided into the following parts: preparation of a water phase and an oil phase, emulsification, pasteurization, cooling/crystallization, and packaging. The ingredients are weighed and mixed as a batch, processed and cooled continuously. The smaller ingredients, such as emulsifiers, stabilizers, salt and vitamins, for example, are dispersed in to the phases according to solubility. The water phase contains the water-soluble ingredients while the oil phase contains the fat-soluble ingredients. In terms of manufacture technology, it is characteristic of the manufacture of a fat spread that the ingredients are added in a certain order. This may be used for influencing the textural properties of a product.

The fat spread composition of the present invention is prepared by emulsifying the oil phase into the water phase to provide an oil-in-water emulsion. A process according to an embodiment of the invention for preparing a fat spread composition is as follows:
preparing a water phase comprising the water-soluble ingredients at temperatures required by the properties of the components, optionally stepwise,
preparing an oil phase containing the fat-soluble ingredients at temperatures required by the properties of the components, optionally stepwise,
emulsifying the oil phase into the water phase to provide an oil-in-water emulsion
pasteurizing the formed oil-in-water emulsion,
carrying out cooling at a surface scraper/heat exchanger, and
packaging the product.

The process steps and/or treatments typical in the preparation of a fat spread composition are performed in a manner known to a person skilled in the art.

In the manufacture of a fat spread composition, the optimum conditions for an economic, inexpensive and efficient production process are employed.

The following examples illustrate the present invention. The examples are not to be construed to limit the claims in any manner whatsoever.

### Example 1—Spread Having a Fat Content of 40%

The manufacture may be divided into the following parts: preparation of a water phase and an oil phase, emulsification, pasteurization, cooling/crystallization, and packaging.

The ingredients are weighed and mixed as a batch, processed and cooled continuously. The smaller ingredients, such as the emulsifier, the hydrocolloid and salt, were dispersed in to the phases according to solubility. The pH of the composition was adjusted to pH value 5.2. The composition is described in Table 1.

TABLE 1

| | |
|---|---|
| Quark % | 35.5 |
| water % | 16.5 |
| butter % | 17 |
| rapeseed oil % | 25 |
| salt % | 0.8 |
| starch % | 2 |
| pectin % | 0.8 |
| emulsifier % | 1.5 |
| acidity regulator % | 0.9 |

### Example 2—Spread Having a Fat Content of 30%

The manufacture may be divided into the following parts: preparation of a water phase and an oil phase, emulsification, pasteurization, cooling/crystallization, and packaging.

The ingredients are weighed and mixed as a batch, processed and cooled continuously. The smaller ingredients, such as the emulsifier, the hydrocolloid and salt, were dispersed in to the phases according to solubility. The pH of the composition was adjusted to pH value 5.0. The composition is described in Table 2.

TABLE 2

| | |
|---|---|
| Quark % | 41 |
| water % | 21 |
| butter % | 16 |
| rapeseed oil % | 17 |
| salt % | 0.8 |
| starch % | 2 |
| pectin % | 0.6 |
| emulsifier % | 1 |
| acidity regulator % | 0.6 |

### Example 3—Spread Having a Fat Content of 30%

The manufacture may be divided into the following parts: preparation of a water phase and an oil phase, emulsification, pasteurization, cooling/crystallization, and packaging.

The ingredients are weighed and mixed as a batch, processed and cooled continuously. The smaller ingredients, such as the emulsifier, the hydrocolloid and salt, were dispersed in to the phases according to solubility. The pH of the composition was adjusted to pH value 5.4. The composition is described in Table 3.

TABLE 3

| | |
|---|---|
| Quark % + yogurt % | 28 + 13 |
| water % | 21 |
| butter % | 16 |
| rapeseed oil % | 17 |
| salt % | 0.8 |
| starch % | 2 |
| pectin % | 0.6 |
| emulsifier % | 1 |
| acidity regulator % | 0.6 |

### Example 4—Spread Having a Fat Content of 30%

The manufacture may be divided into the following parts: preparation of a water phase and an oil phase, emulsification, pasteurization, cooling/crystallization, and packaging.

The ingredients are weighed and mixed as a batch, processed and cooled continuously. The smaller ingredients, such as the emulsifier, the hydrocolloid and salt, were dispersed in to the phases according to solubility. The pH of the composition was adjusted to pH value 5.4. The composition is described in Table 4.

TABLE 4

| | |
|---|---|
| Yogurt % | 41 |
| water % | 21 |
| butter % | 16 |
| rapeseed oil % | 17 |
| salt % | 0.8 |
| starch % | 2 |
| pectin % | 0.6 |
| emulsifier % | 1 |
| acidity regulator % | 0.6 |

### Example 5—Spread Having a Fat Content of 60%

The manufacture may be divided into the following parts: preparation of a water phase and an oil phase, emulsification, pasteurization, cooling/crystallization, and packaging.

The ingredients are weighed and mixed as a batch, processed and cooled continuously. The smaller ingredients, such as the emulsifier, the hydrocolloid and salt, were dispersed in to the phases according to solubility. The pH of the composition was adjusted to pH value 5.3. The composition is described in Table 5.

TABLE 5

| | |
|---|---|
| Quark % | 23 |
| water % | 12 |
| butter % | 24 |
| rapeseed oil % | 36 |
| salt % | 0.8 |
| starch % | 2 |
| pectin % | 0.6 |
| emulsifier % | 1 |
| acidity regulator % | 0.6 |

### Example 6—Spread Compositions

Spread compositions 1, 2, 3 and 4 having a fat content of 30-40% were prepared according to the method of the present invention. The pH of the compositions was 5.4.

The compositions 1 and 3 contained 33% (w/w) milk fat based on the total fat content of the composition.

The compositions 2 and 4 contained 50% (w/w) milk fat based on the total fat content of the composition.

The compositions 1 and 2 contained rapeseed oil (67% (w/w) and 50% (w/w), respectively) as the vegetable oil.

The compositions 3 and 4 contained sunflower oil (67% (w/w) and 50% (w/w), respectively) as the vegetable oil.

The fatty acids profiles of the compositions are shown in Tables 6 and 7.

TABLE 6

| | | 1 | 2 | 3 | 4 |
|---|---|---|---|---|---|
| butyric acid | 4:0 | 1.2 | 1.8 | 1.1 | 1.8 |
| capronic acid | 6:0 | 0.7 | 1.1 | 0.7 | 1.1 |
| caprylic acid | 8:0 | 0.4 | 0.7 | 0.4 | 0.6 |
| capric acid | 10:0 | 1 | 1.5 | 0.9 | 1.4 |
| decenic acid | 10:1 cis | 0.1 | 0.2 | 0.1 | 0.2 |
| lauric acid | 12:0 | 1.1 | 1.8 | 1.1 | 1.7 |
| myristic acid | 14:0 | 3.8 | 5.8 | 3.7 | 5.6 |
| | i-15:0 | 0.1 | 0.1 | 0.1 | 0.1 |
| | ai-15:0 | 0.1 | 0.2 | 0.1 | 0.2 |
| myristoleinic acid | 14:1 cis | 0.3 | 0.5 | 0.3 | 0.5 |
| pentadecanoic acid | 15:0 | 0.3 | 0.5 | 0.3 | 0.5 |
| | 15:1 | 0.1 | 0.1 | 0.1 | 0.1 |
| palmitic acid | 16:0 | 12.8 | 17.6 | 14 | 18.1 |
| | 16:1 cis | 1 | 1.4 | 0.8 | 1.3 |
| heptadecanoic acid | 17:0 | 0.2 | 0.3 | 0.2 | 0.3 |
| | i-18:0 | 0.1 | 0.1 | | |
| heptadecenic acid | 17:1 | 0.1 | 0.1 | 0.1 | 0.1 |
| stearic acid | 18:0 | 4.8 | 6.2 | 5.6 | 7 |
| | 18:1 trans | 0.7 | 1 | 0.7 | 1 |
| oleic acid + isomers | 18:1 cis | 47.1 | 40.3 | 23.5 | 22.9 |
| trans-octadecadienic acids | 18:2 trans | 0.3 | 0.3 | 0.7 | 0.7 |
| linolic acid | 18:2 n-6-cis | 14.5 | 11.1 | 43.7 | 32.8 |
| arachidic acid | 20:0 | 0.4 | 0.3 | 0.2 | 0.2 |
| trans-octadecatrienoic acids | 18:3 trans | 0.4 | 0.3 | 0.1 | 0.1 |
| godoic acid | 20:1 cis (n-9) | 0.8 | 0.5 | 0.1 | 0.1 |
| ALA | 18:3 n-3 cis | 6.4 | 4.9 | 0.2 | 0.2 |
| conj. octadecadienic acids | 18:2 konj | 0.2 | 0.3 | 0.2 | 0.3 |
| behenic acid | 22:0 | 0.2 | 0.1 | 0.5 | 0.4 |
| erucic acid | 22:1 n-9 cis | 0.1 | 0.1 | | |
| lignoceric acid | 24:0 | 0.1 | | 0.2 | 0.1 |
| nervonic acid | 24:1 | 0.1 | 0.1 | | |

TABLE 7

| | 1 | 2 | 3 | 4 |
|---|---|---|---|---|
| Saturated total | 27.6 | 38.5 | 29.2 | 39.3 |
| Monounsaturaed | 49.7 | 43.3 | 25.1 | 25.2 |
| Polyunsaturated | 21.1 | 16.3 | 44 | 33.3 |
| Trans | 1.3 | 1.6 | 1.4 | 1.8 |
| Omega 3 | 6.5 | 4.9 | 0.2 | 0.3 |
| Omega 6 | 14.6 | 11.3 | 43.8 | 32.9 |

### Example 7

The solid fat content at different temperatures and the dropping points of a fat spread composition of the present invention containing 40% fat as well as two different water-in-oil emulsion based spreads containing also 40% fat were determined using standard test procedures and the results are presented in Table 8.

1: oil-in water fat spread composition of the present invention.

2: water-in-oil fat spread composition based on vegetable oils (reference)

3: water-in-oil fat spread composition based on butter and vegetable oils (reference)

TABLE 8
Solid fat content %

| ° C. | 1 | 2 | 3 |
|---|---|---|---|
| 5 | 20.3 | 31.2 | 31.5 |
| 10 | 16.5 | 24.2 | 26.9 |
| 15 | 9.2 | 15.7 | 16.3 |
| 20 | 6.3 | 9.8 | 8.8 |
| 25 | 3.8 | 4.2 | 4.9 |
| 30 | 2 | 1.4 | 1.87 |
| Dropping point ° C. | 32.5 | 28.5 | 30.1 |

As can be seen from Table 8, the solid fat content of the fat spread composition of the present invention is lower than those of the reference spreads in the temperature range of 5 to 25° C. The dropping point of the fat spread composition of the present invention is higher than the ones of the reference spreads.

It will be obvious to a person skilled in the art that, as the technology advances, the inventive concept can be implemented in various ways. The invention and its embodiments are not limited to the examples described above but may vary within the scope of the claims.

1. A fat spread composition in oil-in-water emulsion comprising milk fat, vegetable oil(s), an acidified milk-based mass and water, wherein pH of the spread is in the range of 4.8-6.5 and the fat content of the spread is in the range of 30 to 60% (w/w) based on the weight of the composition.

2. The fat spread composition of claim 1, wherein the spread comprises milk fat about 25 to 50% (w/w) based on the fat content of the composition.

3. The fat spread of claim 2, wherein the spread comprises milk fat about 40 to 50% (w/w) based on the fat content of the composition.

4. The fat spread composition of claim 1, wherein the spread comprises vegetable oil(s) about 50% to 75% (w/w) based on the fat content of the composition.

5. The fat spread composition of claim 4, wherein the spread comprises vegetable oil(s) about 50% to 60% (w/w) based on the fat content of the composition.

6. The fat spread composition of claim 1, wherein the spread comprises saturated fatty acids in the range of about 25-40%, monounsaturated fatty acids in the range of about 25-50% and polyunsaturated fatty acids in the range of about 15-45%, based on the total weight of fatty acids in the composition.

7. The fat spread composition of claim 1, wherein the fatty acid profile of the spread comprises the following fatty acids:

| | |
|---|---|
| C4:0 | 1 to 2% |
| C16:0 | 12 to 18.5% |
| C18:0 | 4.5 to 7.5% |
| C18:3, n-3-cis | 0.2 to 6.5% |

based on the total weight of the fatty acids in the composition.

8. The fat spread composition of claim 1, wherein the fatty acid profile of the spread comprises the following fatty acids:

| | |
|---|---|
| C4:0 | 1 to 2% |
| C4:0 + C6:0 + C8:0 + C10:0 | 3 to 5.2% |
| C14:0 | 3.6 to 5.9% |
| C16:0 | 12 to 18.5% |
| C18:0 | 4.5 to 7.5% |
| C18:1 + isomers | 22 to 48% |
| C18:2, n-6-cis | 10 to 45% |
| C18:3, n-3-cis | 0.2 to 6.5% |

based on the total weight of the fatty acids in the composition.

9. The fat spread composition of claim 1, wherein the fat spread comprises the acidified milk-based mass about 20 to 50% (w/w) based on the total weight of the fat spread composition.

10. The fat spread composition of claim 9, wherein the fat spread comprises an acidified milk-based mass about 25-30% (w/w) based on the total weight of the fat spread composition.

11. The fat spread composition of claim 1, wherein the fat spread comprises 1-6.5% protein.

12. A method for producing a fat spread, wherein said method comprises the steps of:
a) providing a water phase,
b) providing an oil phase,
c) emulsifying the oil phase into the water phase to provide an oil-in-water emulsion,
d) heat-treating the formed emulsion,
e) optionally homogenizing the emulsion,
f) cooling the emulsion,
g) providing a spread,
h) optionally packing the spread.

13. The method of claim 12 comprising the steps of:
a) providing a water phase comprising an acidified milk-based mass, water and optionally at least one hydrocolloid, salts and/or an acidity regulator,
b) providing an oil phase comprising milk fat, vegetable oil and optionally an emulsifier,
c) emulsifying the oil phase into the water phase to provide an oil-in-water emulsion,
d) heat-treating the formed emulsion,
e) optionally homogenizing the emulsion,
f) cooling the emulsion,
g) providing a spread,
h) optionally packing the spread.

14. The method of claim 13 comprising the steps of:
a) providing a water phase comprising an acidified milk based mass about 60-75% (w/w) and water about 25-40% (w/w) based on the weight of the water phase,
b) providing an oil phase comprising milk fat about 25 to 50% (w/w) and vegetable oil about 50-75% (w/w) based on the weight of the oil phase,
c) emulsifying the oil phase into the water phase to provide an oil-in-water emulsion,
d) heat-treating the formed emulsion,
e) optionally homogenizing the emulsion,
f) cooling the emulsion,
g) providing a spread,
h) optionally packing the spread.

15. The method of claim 13, wherein the method comprises a step of adjusting the pH to a range of 4.8 to 6.5.

16. The method of claim 13, wherein the fat content of the spread is in the range of 30 to 60% (w/w) based on the weight of the composition.

17. The fat spread composition of claim 1, wherein the acidified milk-based mass is selected from quark and/or yogurt.

18. The method of claim 13, wherein the acidified milk-based mass is selected from quark and/or yogurt.
